(19) United States
(12) Patent Application Publication
(10) Pub. No.: US 2002/0120512 A1
(43) Pub. Date: Aug. 29, 2002

(54) User interface for a profile-driven commerce system

(76) Inventors: James M. McKinley, Austin, TX (US); Jeffery P. Hoogendam, Austin, TX (US); Erika Bennett, Austin, TX (US)

Correspondence Address: TAYLOR RUSSELL & RUSSELL, P.C., 4807 SPICEWOOD SPRINGS ROAD, BUILDING ONE, SUITE 1200, AUSTIN, TX, 78759, US

(21) Appl. No.: 10/063,430

(22) Filed: Apr. 23, 2002

Related U.S. Application Data
(63) Continuation-in-part of application No. 09/794,786, filed on Feb. 27, 2001.

(51) Int. Cl. G06F 17/60

(52) U.S. Cl. 705/14; 705/26

(57) ABSTRACT

A method in a computer system for enabling a user to interact with a profile-driven commerce system, comprising generating a plurality of display areas for receiving a consumer's geographic location, for receiving the consumer's monthly average bill amount for a provided good or service, and for receiving the consumer's selection of one of a plurality of predetermined lifestyle profiles; receiving the consumer's geographic location; receiving the consumer's monthly average bill amount for the provided good or service; and receiving the consumer's selection of one of the predetermined lifestyle profiles.

### CROSS REFERENCE TO RELATED APPLICATIONS

This application is a continuation-in-part of U.S. application Ser. No. 09/794,786, filed on Feb. 27, 2001.

### BACKGROUND OF INVENTION

This invention relates generally to assisting consumers in the purchase of goods and services. More particularly, the invention is directed to a user interface for a profile-driven commerce system, wherein a profile of consumer activity and lifestyle is related to specific market offerings from providers of goods and services, in order to obtain a most benefit-effective match of user profile and lifestyle information with market offerings. Consumers may be any individual, group of individuals, organization or entity that consumes goods and services.

There are a number of paradigms that describe the interactions between a buyer and a seller in affecting a trading transaction for goods and services. Bartering has historically been and continues to be used in many parts of the world to arrive at an agreement to trade by exchanging one type of goods or services for another. In this paradigm, offers and counter-offers are exchanged between two parties until an agreement to trade is reached through a process of haggling.

With the industrial revolution came the mass production of goods and services. With many competing goods and services, it became necessary for suppliers of these goods and services to use means for attracting buyers to their products through various forms of marketing, merchandising and advertising. This often required the supplier to designate an advertised price for the goods and services that was relatively firm or fixed, eliminating much of the haggling that was formerly involved in exchange transactions. This resulted in a traditional paradigm where the supplier controlled the price of the goods and services that were offered for sale, leaving a potential buyer to accept the quoted price or look elsewhere for a more desirable transaction.

Auctions and the various stock and commodity exchanges form another paradigm where neither a single buyer nor seller controls the price of a product or service. In this paradigm, the buyers as a group determine the selling price that the seller may accept or reject. This provides an efficient process for matching buyers and seller where neither buyer nor seller is favored.

In the present post-industrial society, a majority of e-commerce activities have automated the traditional paradigm, where sellers set the price, terms and conditions of an offer and a buyer may choose to accept or reject the offer. There have been a limited number of buyer-driven schemes for affecting a purchase of goods and services, such as electronic bulletin boards and traditional request for proposals (RFPs). Since these schemes either have limited exposure or involve high cost items requiring a substantial buyer investment, their use has been generally limited to a relatively few items. A new buyer-driven paradigm has been implemented on the Internet that enables efficient transactions involving goods and services. Under this paradigm, buyers name their price for goods and services in order to locate and buy these items. However, under this paradigm, information that is available to the buyer before a transaction is consummated is limited. Many consumers are uncomfortable committing to a purchase with little information about the goods or services they are buying.

Consumers often face a difficult task in selecting and managing the purchase of goods and services. The market for basic recurring purchases of goods and services includes, for example, telecommunications, electricity, natural gas, and entertainment services. These markets are undergoing a tremendous amount of change as they are transformed from regulated, monopolistic, fixed price markets to those with numerous competitors. For example, the Telecom Act of 1996 transformed the industry from just a few players to over 1,200 carriers. In the long distance market, there are over 5,000 long distance plans with rates between plans varying by 500%. In Pennsylvania, consumers have a choice of 30 providers of electricity. Internet connectivity services provide choices of dial-up, xDSL, cable modem, wireless and satellite choices. Other markets are beginning to deregulate as well.

All of this change and deregulation has led to a proliferation of choices. In the past, it was relatively simple: consumers of these goods and services had no choice of market offerings such as various providers or pricing plans. Today, with deregulated markets, there are thousands of optional plans with widely varying rates. The overwhelming number of choices has left many consumers confused and uncertain as to how to compare, select and manage the purchase of these basic recurring services. Studies have shown that over 70% of long distance telephone users are not certain that they are getting the best plan for their calling habits. This confusion and uncertainty has created a dilemma for consumers: spend an inordinate amount of time gathering and analyzing information on all of the different market offerings to find which goods and services are best for their needs, or pay more than necessary for the same quality of goods and services.

Many of the recurring goods and services required by consumers are commodity products that consumers do not want to shop for on a monthly basis. Since there is little differentiation in the quality of these commodity products, many providers of these products have tailored several offerings of these products to target specific market segments, thereby providing an opportunity to differentiate the prices of their products from those offered by their competition. These markets segments are identified primarily by the product usage or lifestyle characteristics of the consumers within the targeted market segments. The result is often a plethora of complex market offerings that make it extremely difficult, if not impossible, for a consumer to make an objective side-by-side comparison in order to obtain an offering that is most suitable for a particular consumer's usage or lifestyle characteristics. An almost continual shifting of characteristics of these market offerings such prices and quality of these goods and services further compound the situation. The marketplace becomes increasingly complex and confusing as the number of competitive market offerings and options continues to rise dramatically. Consumers are further pressured to save time and money in their lives and require help to make decisions.

This environment has created a need for a new paradigm for buyer-driven commerce that creates a more efficient method for consumers of goods and services to match their consumption or lifestyle characteristics to that of one of the many market offerings by suppliers of these recurring goods and services to achieve a benefit-effective match. Profile-driven commerce (PDC) matches the buying requirements or lifestyle profile of consumers to an offering by a product or service supplier to solve the problems of confusion and over-paying. However, in order to effectively implement a PDC system, a user interface is needed that provides consumers with convenient access to and use of the PDC system.

Some prior art systems attempt to recommend goods and services, based on consumer inputs. However, the information returned is typically not immediately useful to the consumer using the system. First, the prior art systems lack the ability to profile a consumer, in order to accurately recommend goods and service providers based on lifestyle, rather than mere cost. Following from this, prior art systems typically only return provider names and rates, rather than actually calculating a consumer's cost under a certain market offering. This is significant, because many goods and service providers use varying rate structures for their goods or services, even under the auspices of a single market offering or plan. For instance, if a consumer were seeking to lower monthly long distance cost, the consumer's day, evening, Saturday, and Sunday calling habits would factor in at different rates. Merely returning rate information would not be likely to aid the consumer, because the consumer would need to manually calculate a monthly or periodic bill estimate therefrom.

Additionally, when results are returned, a consumer needs to be able to manipulate a user interface that displays side-by-side comparisons of providers and the details of their market offerings. The prior art does not currently provide this. The prior art also does not provide a means for switching to a goods or service provider directly via the user interface used to input data and receive recommended market offerings. Finally, the prior art does not provide a consumer with a secure means for retrieving recommendations and information, because personal identification and contact information is gathered prior to the search for lower-cost service providers and used to drive elements of the search.

Thus, there is a need for a user interface for a PDC system, which has the ability to gather information regarding a consumer's lifestyle profile, in order to increase the accuracies of its recommendations, based on factors other than mere cost. The user interface needs to display pre-calculated monthly or periodic payments for the consumer, rather than only rate information, in response to data received from the consumer. The user interface needs to display side-by-side comparisons of market offering details, for those providers selected by a consumer. The user interface needs to provide a means for switching to a different provider via the same interface used to input data and view market offerings. And, the user interface needs to provide information and recommendations about market offerings that could benefit the consumer, prior to gathering contact and identity information from the consumer.

Hence, it is an object of the current invention to provide a user interface for a Profile-Driven Commercial system, which allows consumers to easily interact with and take advantage of the benefits of the PDC system. The current invention fulfills all the needs described above, and others, as will be illustrated in the descriptions below and accompanying figures. The user interface of the current invention gathers information regarding a consumer's lifestyle profile. The user interface displays pre-calculated monthly or periodic payments for the consumer, in response to data received from the consumer. The user interface displays side-by-side comparisons of market offering details, for those providers selected by a consumer. The user interface provides a means for switching a consumer to a different provider, via the same interface used to input data and view market offerings. And, the user interface collects no contact or identity information prior to displaying its recommendations about market offerings that could benefit the consumer.

### SUMMARY OF INVENTION

The present invention is directed to a profile driven method in a computer system for displaying market offerings to a consumer, which comprises displaying information about a selected category of goods and services, receiving consumer selected profile information that most closely matches consumer usage of the selected goods and services category, and displaying one or more market offerings in the selected goods and services category that provides a highest benefit to the consumer based on the selected profile information. The method may further comprise receiving an indicia of a consumer geographic location, and displaying one or more market offerings in the selected goods and services category that provides a highest benefit to the consumer based on the selected profile information and the consumer geographic location. The method may further comprise receiving a designated market offering from the consumer for supplying the selected category of goods and services to the consumer. The step of displaying one or more market offerings may comprise displaying one or more market bundles where each market bundle includes a plurality of market offerings from different categories of goods and services. The method may further comprise displaying a detailed comparison of the market offerings in the selected goods and services category that provides the highest benefit to the consumer based on the selected profile information. The method may further comprise receiving a request from the consumer for receiving future notification of high benefit market offerings. The method may further comprise displaying estimated benefits of the market offerings in the selected goods and services category that provides a highest benefit to the consumer based on the selected profile information. The step of displaying estimated benefits may comprise displaying estimated benefits selected from the group consisting of monthly fees, quality rating, lowest cost, highest quality, highest reliability, fastest response, consumer support services, available promotions, equipment costs included, installation charges included, and prompt delivery. The step of displaying information may comprise displaying information about a selected category of goods and services chosen from the group consisting of local telephone service, variable cost long distance, fixed cost long distance service, wireless service, broadband service, dial-up Internet service, natural gas service, electric service, entertainment service, airline reservation service, information service, grocery service, financial service, insurance, commodity goods, cable television, satellite television, credit cards, conference calling and calling cards. The step of receiving consumer selected profile information may comprise receiving consumer selected profile information chosen from the group consisting of periodic bill amounts, time related usage information, geographic related usage information, number of users, frequency related usage information, desired features and risk tolerance. The step of receiving an indicia of a consumer geographic location may comprise receiving an indicia of a consumer geographic location selected from the group consisting of telephone area code, telephone exchange digits, city designation, state designation, and postal code. The step of displaying one or more market offerings may comprises displaying a provider name for the highest benefit market offering, displaying the monthly average bill amount received form the consumer, displaying an estimated average monthly bill amount for the highest benefit market offering, displaying a monthly savings amount, and displaying a quality rating for displayed highest benefit market offering. A software program may be embodied on a computer-readable medium, incorporating the method above.

Another embodiment of the present invention is a user interface method for a profile driven commerce system for displaying market offerings to a consumer, which may comprise selecting a category of goods and services by a consumer, viewing displayed information about the selected category of goods and services, selecting consumer profile information that most closely matches consumer usage of the selected goods and services category, and viewing one or more market offerings in the selected goods and services category that provides a highest benefit to the consumer based on the selected profile information. The method may further comprise entering an indicia of consumer geographic location by the consumer, and viewing one or more market offerings in the selected goods and services category that provides a highest benefit to the consumer based on the selected profile information and the consumer geographic location. The method may further comprise selecting a designated market offering by the consumer for supplying the selected category of goods and services to the consumer. The step of viewing one or more market offerings may comprise viewing one or more market bundles where each market bundle includes a plurality of market offerings from different categories of goods and services. The method may further comprise viewing a detailed comparison by the consumer of the market offerings in the selected goods and services category that provides the highest benefit to the consumer based on the selected profile information. The method may further comprise inputting a request by the consumer for receiving future notification of high benefit market offerings. The method may further comprise viewing estimated benefits by the consumer of the market offerings in the selected goods and services category that provides a highest benefit to the consumer based on the selected profile information. The step of viewing estimated benefits may comprise viewing estimated benefits selected from the group consisting of monthly fees, quality rating, lowest cost, highest quality, highest reliability, fastest response, consumer support services, available promotions, equipment costs included, installation charges included, and prompt delivery. The step of viewing displayed information may comprise viewing displayed information about a selected category of goods and services chosen from the group consisting of local telephone service, variable cost long distance, fixed cost long distance service, wireless service, broadband service, dial-up Internet service, natural gas service, electric service, entertainment service, airline reservation service, information service, grocery service, financial service, insurance, commodity goods, cable television, satellite television, credit cards, conference calling and calling cards. The step of selecting consumer profile information may comprise selecting consumer profile information chosen from the group consisting of periodic bill amounts, time related usage information, geographic related usage information, number of users, frequency related usage information, desired features and risk tolerance. The step of entering an indicia of a consumer geographic location may comprise receiving an indicia of a consumer geographic location selected from the group consisting of telephone area code, telephone exchange digits, city designation, state designation, and postal code. The step of viewing one or more market offerings may comprise viewing a provider name for the highest benefit market offering, viewing the monthly average bill amount received form the consumer, viewing an estimated average monthly bill amount for the highest benefit market offering, viewing a monthly savings amount, and viewing a quality rating for each displayed highest benefit market offering. A software program may be embodied on a computer-readable medium, incorporating a computer-implemented method of providing the user interface method given above.

Yet another embodiment of the present invention is a computer system for displaying market offerings to a consumer, which comprises means for displaying information about a selected category of goods and services, means for receiving consumer selected profile information that most closely matches consumer usage of the selected goods and services category and means for displaying one or more market offerings in the selected goods and services category that provides a highest benefit to the consumer based on the selected profile information. The means for displaying may be a computer display terminal. The means for receiving may be a computer keyboard. The means for receiving may be a computer mouse.

### BRIEF DESCRIPTION OF DRAWINGS

These and other features, aspects, and advantages of the present invention will become understood with regard to the following description, appended claims and accompanying drawings, where:

FIG. 1 is a flow diagram illustrating steps of a method for allowing a user to interact with a profile-driven commerce system;

FIG. 2 is a flow diagram illustrating steps of a method for allowing a user to interact with a profile-driven commerce system;

FIG. 3 is a schematic diagram of components of a system for implementing a user interface for a profile-driven commerce system;

FIG. 4 shows an example of a user interface for collecting information from a user, in which the user interface is embodied in an Internet web page;

FIG. 5A and FIG. 5B show another example of a user interface for collecting information from a user, in which the user interface is embodied in an Internet web page;

FIG. 6A shows an example of a user interface for displaying market offerings in response to inputs received from a user;

FIG. 6B shows an example of a user interface for displaying market offerings in response to inputs received from a user, in which a side-by-side comparison is displayed;

FIG. 6C shows an example of a user interface for registering a user to receive updates on market offerings in response to user inputs; and

FIG. 7 shows an example user interface embodied in an Internet web page, in which a user may choose either the user interface shown in FIG. 4 or the user interface shown in FIG. 5A and 5B.

### DETAILED DESCRIPTION

Referring now to the figures, the present invention is directed a method in a computer system, for enabling a user to interact with a profile-driven commerce (PDC) system. The current invention may be used in any PDC system, which identifies beneficial market offerings for the periodic, recurring use of any good or service, whose cost is affected by varying price structures and usage factors. Such goods and services may include local and long distance telephone service; cellular telephone service; Internet usage and accompanying services, such as DSL, etc.; utility services, such as electric power; financial services; bulk commodities; and other goods and services. Additionally, the current invention may be used where more than one goods and services are used together and sold separately or in bundles.

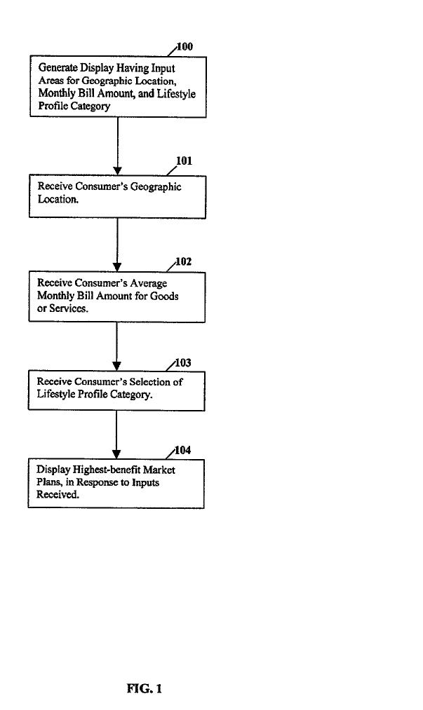

Referring to FIG. 1, a display is generated, in accordance with step 100. The display contains areas for receiving inputs from a consumer. In the embodiment shown in FIG. 1, the input areas include at least one input area for receiving a consumer's geographic location. This may comprise an area in which a consumer enters any suitable information, from which the consumer's geographic location can be determined. This may include telephone information, city and state information, or postal code information. In one embodiment, the input area for receiving geographic location comprises an area in which a consumer enters the consumer's area code and exchange digits.

In the embodiment in FIG. 1, the input areas also include at least one area for receiving a consumer's estimated monthly bill amount for a provided good or service. For example, if the profile-driven commerce system is used for long distance service, a consumer could use this input area to enter an estimated average monthly long distance bill amount. The input area could also be used to enter an estimated average monthly bill amount for other commodities that are paid for on a regular and periodic basis, even if the period of payment is not equal to a monthly period. For instance, if the consumer pays for the provided good or service on a quarterly, semi-annual, or annual basis, the consumer may still enter an average monthly bill amount. Alternatively, the consumer could be given the option to enter a periodic amount and the basis of the period, from which a monthly amount could be calculated. The period may include annual, semi-annual, or quarterly periods, for example, or a contracted period of service, such as in a pre-paid plan.

In the embodiment in FIG. 1, the input areas also include at least one area for receiving a consumer's selection of a lifestyle profile category. A lifestyle profile category may include any suitable category that relates usage of the provided good or service being offered, to a general lifestyle of the consumer that affects or promulgates usage of the provided good or service. For instance, if the profile-driven commerce system is used for long distance service, various lifestyle profile categories might be presented that would affect long distance usage. For example, whether a person makes calls for business, on nights or weekends, predominantly in state or out of state, etc., may affect long distance usage and market offerings for which the consumer is eligible. Thus, in addition to geographic location and average monthly bill, the input areas of the generated display include an area that provides the user with selectable choices of predetermined lifestyle profile categories. The choices may be displayed in conjunction with a pull-down menu, graphic icons, graphic checkboxes, or other computer-implemented graphic means for allowing a user to select one or more of the categories, as known to those skilled in the art.

In accordance with step 101, the consumer enters a geographic location into the appropriate input area or areas of the display, and the consumer's geographic location is received. In accordance with step 102, the consumer enters an estimated average monthly bill amount into the appropriate input area or areas of the display, and the consumer's estimated average monthly bill amount for the provided good or service is received. In accordance with step 103, the consumer selects at least one predetermined lifestyle profile category, and the consumer's selection is received.

In response to receiving a geographic location, estimated monthly bill amount, and lifestyle profile category from the consumer, at least one highest-benefit market offering for the provided good or service is displayed, in accordance with step 104. The market offerings comprise offerings of the good or service by various service providers, which would most benefit the consumer, given the inputs received. The display of market offerings includes a name for each provider listed and an estimated average monthly bill amount for the provider's market offering that most benefits the consumer, given the inputs received in steps 101-103.

The display of highest benefit market offerings may also include a quality rating for each market offering listed. The quality rating may be based on suggestions of other consumers, FCC statistics, and the like. The quality rating may comprise any rating system suitable for clearly conveying a relative quality level among the market offerings displayed, such as a four or five star system, numbered rating system, or the like. The user interface, by which the market offerings are displayed, may include a means for sorting the market offerings according to quality rating. The display of highest benefit market offerings may also include a means for switching the consumer's provision of the good or service to the provider of a market offering that the consumer chooses. The means for switching may comprise any suitable means for a consumer to enter a choice to switch to a provider. This may include graphic icons, pull-down menus, graphic checkboxes, graphic buttons, such as a “Select This Plan” button, and the like. In one embodiment, this means comprises at least one selectable hypertext link.

The display of highest benefit market plans may also include a separate display of a best market offering, which represents the best of the highest benefit market offerings displayed. This display of a best market offering includes the provider's name and an estimated average monthly bill amount for the market plan offered by the provider that most benefits the consumer, based on the inputs received. The display of a best market offering may also include an estimated monthly savings amount, an estimated period savings amount, where the consumer has entered an estimated bill amount for a period other than a month, and a yearly savings amount. This separate display may also include a means for the consumer to choose to switch to the provider displayed. This may include graphic icons, pull-down menus, graphic checkboxes, graphic buttons, such as a “Select This Plan” button, and the like. In one embodiment, this means comprises at least one selectable hypertext link.

In the method shown in FIG. 1, the highest benefit market offerings may be determined, using assumptions about rates, call length, and cal distribution. For instance, where a user enters a geographic location, an average monthly or periodic bill amount, and a lifestyle selection, highest benefit market offerings may be determined, by assuming an industry standard rate, call length, and call distribution (in-state or out-of-state, on days, evenings, Saturdays and Sundays). These assumptions may be shaped by the lifestyle profile choice selected by the user. The assumed information may be provided by sources, such as the Federal Communications Commission (FCC) or private survey sources, including on-line consumer data gathering sources that may be tied to the PDC system employing the user interface of the current invention.

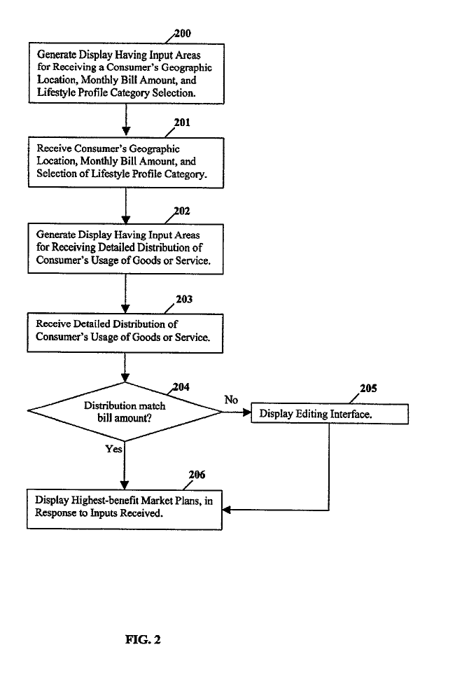

Referring now to FIG. 2, a display is generated, in accordance with step 200. The display contains areas for receiving inputs from a consumer. In the embodiment shown in FIG. 2, the input areas include at least one input area for receiving a consumer's geographic location. This may comprise an area in which a consumer enters any suitable information, from which the consumer's geographic location can be determined. This may include telephone information, city and state information, or postal code information. In one embodiment, the input area for receiving geographic location comprises an area in which a consumer enters the consumer's area code and exchange digits.

In the embodiment shown in FIG. 2, the input areas also include at least one area for receiving a consumer's estimated monthly bill amount for a provided good or service. For example, if the profile-driven commerce system is used for long distance service, a consumer could use this input area to enter an estimated average monthly long distance bill amount. The input area could also be used to enter an estimated average monthly bill amount for other commodities that are paid for on a regular and periodic basis, even if the period of payment is not equal to a monthly period. For instance, if the consumer pays for the provided good or service on a quarterly, semi-annual, or annual basis, the consumer may still enter an average monthly bill amount. Alternatively, the consumer could be given the option to enter a periodic amount and the basis of the period, from which a monthly amount could be calculated.

In the embodiment in FIG. 2, the input areas also include at least one area for receiving a consumer's selection of a lifestyle profile category. A lifestyle profile category may include any suitable category that relates usage of the provided good or service being offered, to a general lifestyle of the consumer that affects or promulgates usage of the provided good or service. For instance, if the profile-driven commerce system is used for long distance service, various lifestyle profile categories might be presented that would affect long distance usage. For example, whether a person makes calls for business, on nights or weekends, predominantly in state or out of state, etc., may affect long distance usage and market offerings for which the consumer is eligible. Thus, in addition to geographic location and average monthly bill, the input areas of the generated display include an area that provides the user with selectable choices of predetermined lifestyle profile categories. The choices may be displayed in conjunction with a pull-down menu, graphic icons, graphic checkboxes, or other computer-implemented graphic means for allowing a user to select one or more of the categories, as known to those skilled in the art.

In accordance with step 201, the consumer enters a geographic location into the appropriate input area or areas of the display, and the consumer's geographic location is received. The consumer also enters an estimated average monthly bill amount into the appropriate input area or areas of the display, and the consumer's estimated average monthly bill amount for the provided good or service is received. The consumer also selects at least one predetermined lifestyle profile category, and the consumer's selection is received.

In accordance with step 202, a display is generated that includes areas for receiving a detailed distribution of the consumer's usage of the provided goods or service. The detailed distribution may comprise any suitable breakdown of a consumer's regular usage of a commodity or service by the month or other period. The breakdown may include units used per month or period, numbers of occasions of usage per month or period, and the like. The detailed distribution may be further broken down by manners of use that might affect the rates charged the consumer, such as geographic distribution of usage, time or season of usage, and the like. For instance, if the profile-driven commerce system provides long distance service, then the detailed distribution might include a distribution of a consumer's calls or minutes of calls broken down by time of day or weekends, as this affects long distance calling rates. The detailed distribution may be further refined in such an example, by the geographic location to which the calls are placed, such as in-state or out-of-state. In accordance with step 203, the consumer enters a detailed distribution of usage of the provided goods or service, and the detailed distribution is received.

In accordance with step 204, the detailed distribution of usage and the monthly bill amount are compared to ensure that the two match each other within tolerances set by the system operator. For instance, suppose the current invention is used in conjunction with long distance service provisioning. If a user enters a total distribution of 1000 minutes of calling for a month, but a monthly bill of $1.00, then the two do not match within reasonable expectations of long distance rate structures. Thus, it would be difficult for the PDC system to accurately find market offerings that would benefit the consumer. Thus, the two entries are compared and found to match or not match, within certain tolerances.

If the two do not match, then an editing interface is displayed to the consumer, in accordance with step 205. The editing interface explains that the pairing of the entered monthly bill amount and the usage distribution do not reasonably match each other. The consumer is given the opportunity to edit the figures that were previously entered in steps 201-203.

In response to receiving a geographic location, lifestyle profile category, and matching estimated monthly bill amount and detailed distribution of usage from the consumer, at least one highest-benefit market offering for the provided good or service is displayed, in accordance with step 206. The market offerings comprise offerings of the good or service by various service providers, which would most benefit the consumer, given the inputs received. The display of market offerings includes a name for each provider listed and an estimated average monthly bill amount for the provider's market offering that most benefits the consumer, given the inputs received in steps 201-205.

The display of highest benefit market offerings may also include a quality rating for each market offering listed. The quality rating may be based on suggestions of other consumers, FCC statistics, or the like. The quality rating may comprise any rating system suitable for clearly conveying a relative quality level among the market offerings displayed, such as a four or five star system, numbered rating system, or the like. The display of highest benefit market offerings may also include a means for switching the consumer's provision of the good or service to the provider of a market offering that the consumer chooses. The means for switching may comprise any suitable means for a consumer to enter a choice to switch to a provider. This may include graphic icons, pull-down menus, graphic checkboxes, graphic buttons, such as a “Select This Plan” button, and the like. In one embodiment, this means comprises at least one selectable hypertext link.

The display of highest benefit market plans may also include a separate display of a best market offering, which represents the best of the highest benefit market offerings displayed. This display of a best market offering includes the provider's name and an estimated average monthly bill amount for the market plan offered by the provider that most benefits the consumer, based on the inputs received. The display of a best market offering may also include an estimated monthly savings amount, an estimated period savings amount, where the consumer has entered an estimated bill amount for a period other than a month, and a yearly savings amount. This separate display may also include a means for the consumer to choose to switch to the provider displayed. This may include graphic icons, pull-down menus, graphic checkboxes, graphic buttons, such as a “Select This Plan” button, and the like. In one embodiment, this means comprises at least one selectable hypertext link.

The display of highest benefit market offerings may also include a means for a user to select certain ones of the market offerings for side-by-side comparison of details of the market offerings. This may include any suitable means for a user to select multiple ones of the market offerings displayed, including graphic icons, pull-down menus, graphic checkboxes, graphic buttons, and the like. The display may then include a means for inputting an option to compare the selected plans, such as a “Compare” graphic button, or the like, which may be selected once certain plans are selected.

The display of highest benefit market offerings may also include an interactive graphic means for a user to alter the relative usage distribution entered in step 203, while viewing changes in monthly bill amounts for displayed market offerings that are selected by the user, for the displayed best market offering, for all displayed market offerings, or any combination of these. The display may include a means for selecting the plans that the user would like to interactively view. The display may then include an illustration of the relative usage distribution entered by the user in step 203, along with a means for increasing and decreasing usage types. In one embodiment, this is accomplished by providing a set of interactive graphic slider bars, which allow the user to easily increase or decrease relative amounts of usage types. When the slider bars are manipulated, the monthly bill amounts for each selected market offering is recalculated and the new amount displayed.

For instance, if the PDC system were used for long distance services, the user would be able to view the calling distribution entered, such as day, evening, in-state, out-of-state, etc. The user would be able to select certain market offerings displayed, or all of them, whether by the same means as choosing market offerings for side-by-side comparison, or by other means. The user would then be able to manipulate the relative distribution of calls, by manipulating graphic slider bars, for example. In response to the user's manipulation of call distribution, the monthly bill amounts for each market offering chosen by the user would change to reflect the new distribution of calls under the market offering.

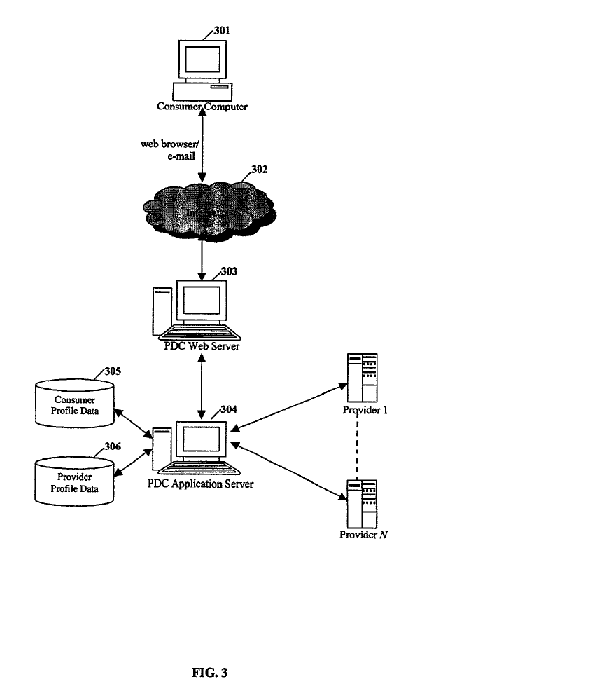

FIG. 3 shows an example configuration of a profile-driven commerce (PDC) system, with which the currently invented method may be used. Using a consumer's computer 301, a consumer communicates with a PDC web server 303 via the Internet 302. The PDC web server 303 hosts PDC web pages that can be accessed via a web browser. The PDC web pages enable a consumer to enter consumer usage profile and lifestyle information and view displayed comparisons of selected market offerings for provided goods and service. The PDC web server 303 communicates with a PDC application server 304 to provide consumer usage profile and lifestyle information and receive information regarding selected goods and service provider plans. The PDC application server 304 stores consumer profile and lifestyle information in a PDC consumer profile and lifestyle database 305.

The PDC application server 304 also communicates with goods and service providers (1-N) 307 to obtain information on the various plans offered by the goods and service providers 307. Most goods and service providers 307 may make plan pricing and plan information directly available to the PDC application server 304. The PDC application server 304 stores this information about the goods and service provider plans in a PDC provider profile database 306. Search algorithms within the PDC application server 304 compare consumer usage profile and lifestyle data in the PDC consumer profile and lifestyle database 305 with the goods and service provider plan information stored in the PDC provider profile database 306 to locate the lowest priced plan suitable for a particular consumer profile and lifestyle. The PDC application server 304 has the capability to request a switch of a consumer's goods and service provider, based on a request by the consumer, using the switching means described with reference to FIG. 1. The PDC application server 304 also has the capability to provide continued, proactive searching activity at a consumer's request in order to find a suitable goods and service provider plan with the highest benefit.

Alternatively, a form for collecting consumer data may be e-mailed from the PDC web server 303 to the consumer's computer 301, via the Internet 302. The consumer may compete the form and return it via e-mail to the PDC web server 303. The information on the form is then communicated to the application server 304, and results are returned. The results may be e-mailed to the consumer computer 301, or a link to a results page on the PDC web server 303 may be e-mailed to the consumer computer 301.

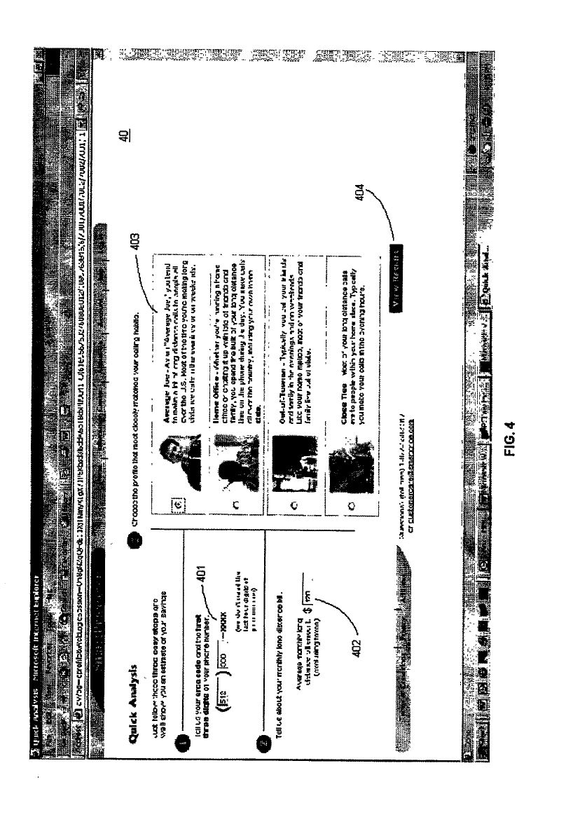

FIGS. 4-7 illustrate example embodiments of the current invention, in which a user interface is disposed as a number of Internet web pages, though other means of delivery may be used in implementing the current invention, as discussed. The Internet web pages of the following example embodiments may be created using any suitable means for dynamic generation of Hypertext Markup Language (HTML). Such means may include the use Java server pages interacting with Java servlets; by using HTML pages with embedded scripts, such as Microsoft's® Active Server Pages (ASP) or Personal Home Page tools (PHP), for example; and by using methods or conventions for passing data between applications and servers, such as Common Gateway Interface (CGI) or FastCGI.

As an alternative to dynamic HTML generation means, the Internet web pages of the following example embodiments may be created using self-contained programs or applications that can be sent along with a page, such as applets, Object Linking and Embedding custom controls, or Microsoft's® ActiveX controls.

FIG. 4 shows a user interface for a PDC system, in accordance with one embodiment of the current invention. FIG. 4 shows an Internet web page 40. Using the web page 40, the consumer may input a geographic location, by entering an area code and the exchange (first three) digits of a phone number, at input area 401. The consumer then enters an amount spent for an average monthly long distance bill, at input area 402. Third, the consumer selects one of several predetermined profile and lifestyles that most closely match the consumer's calling habits, shown at input area 403. These predetermined profiles and lifestyles use standard U.S. calling pattern assumptions to fill in gaps in the consumer usage profile and lifestyle information. And fourth, the consumer selects the View Results button 404, causing the highest benefit market offerings, described previously, to be displayed.

FIG. 5A shows a user interface for a PDC system, in accordance with a second embodiment of the current invention. FIG. 5A shows Internet web page 50. Using the web page 50, the consumer may input a geographic location, by entering an area code and the exchange (first three) digits of a phone number, at input area 501. The consumer may then enter an amount spent for an average monthly long distance bill, at input area 502. Third, the consumer enters the number of minutes spent calling long distance in a typical month, at input area 503. Fourth, the consumer selects one of several predetermined profiles and lifestyles that most closely match the consumer's calling habits, shown at input area 504. These predetermined profiles and lifestyles use standard U.S. calling pattern assumptions to fill in gaps in the consumer usage profile and lifestyle information. Next, the consumer selects a graphic button that is suitable for taking the user to a next web page, where more input may be entered. For example, the user may select the “On to Step 4” button shown at 505, causing the screen shot shown in FIG. 5B to be displayed.

FIG. 5B shows Internet web page 51, for entering additional data. The web page shown at 51 is displayed after a consumer selects the “On to Step 4,” or like button, as described with reference to FIG. 5A. The consumer enters usage profile and lifestyle information regarding the number of in-state and out-of-state telephone calls per month made during the day, at input area 511; during the evening, at input area 512; on Saturdays, at input area 513; and on Sundays, at input area 514. In addition, the consumer enters the number of international calls per month made to foreign countries, at input areas 515-517. The consumer must then select the View Results button 518, causing the highest benefit market offerings, described previously, to be displayed.

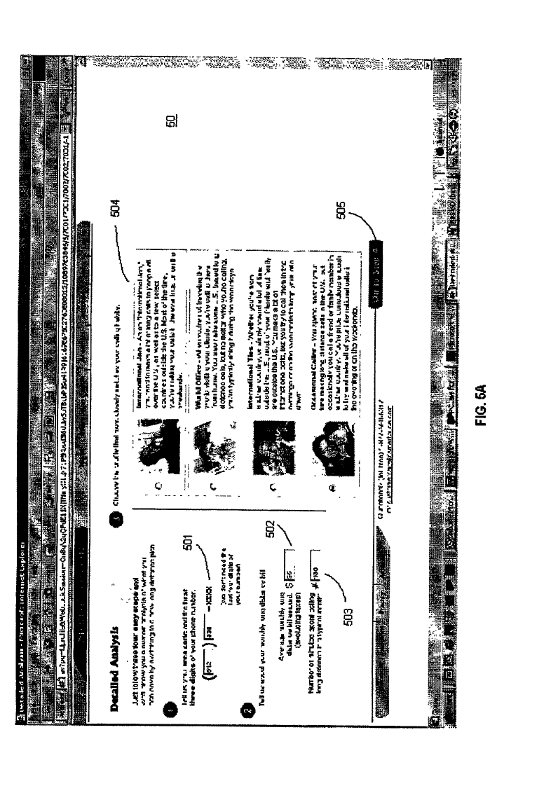

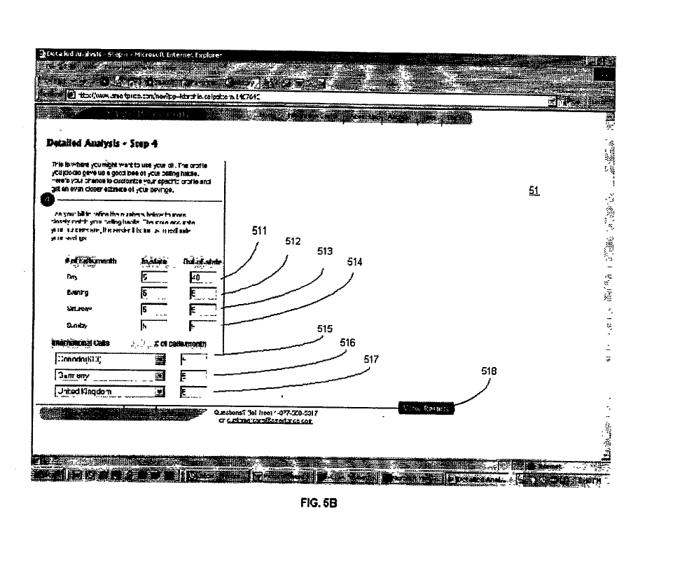

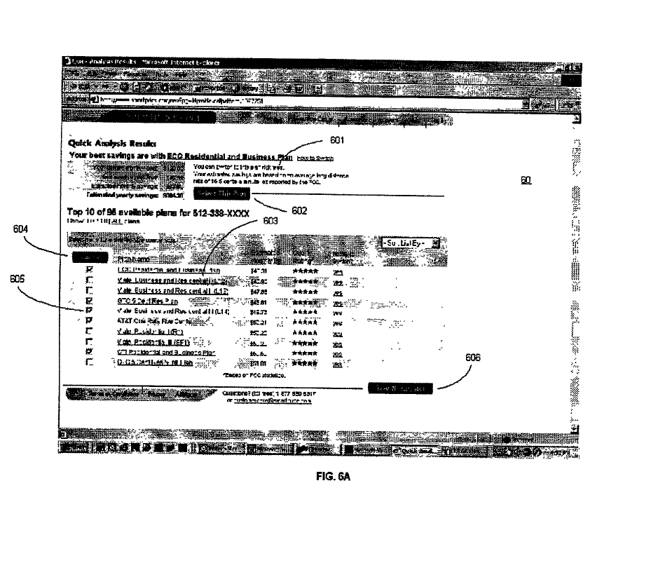

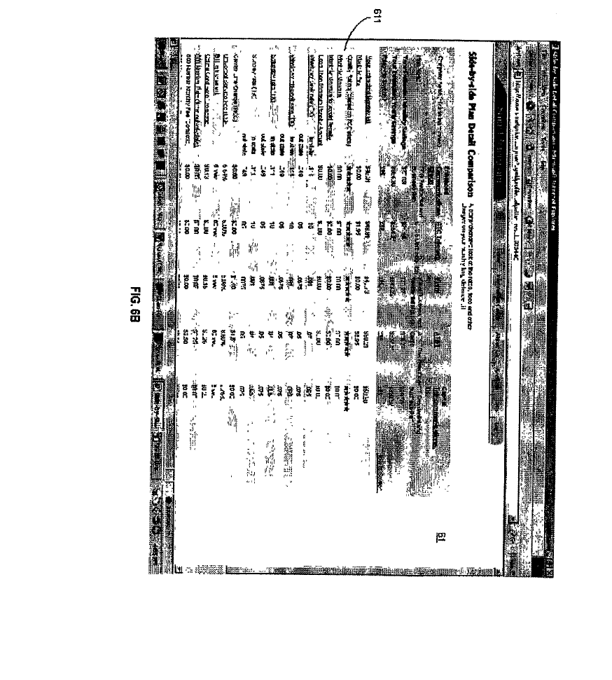

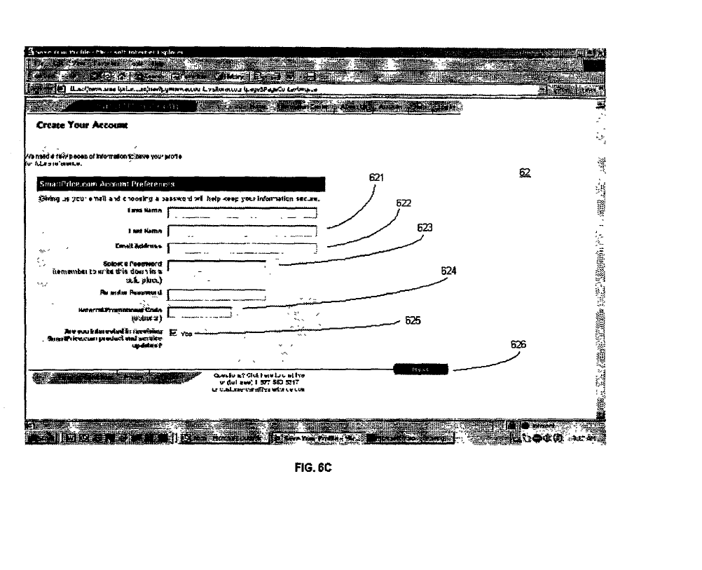

Turning now to FIG. 6B, FIG. 6B shows an Internet web page 60 displaying highest benefit market offerings, described previously, based on the consumer data entered by a user in FIG. 4 or FIG. 5A and 5B. The market offering that the PDC system found to provide the best savings, by matching consumer usage profile and lifestyle information to goods and service provider plan profile data, is shown at the top of the web page 60, in area 601. If the consumer wishes to switch to this recommended plan, a Select This Plan button 602 may be clicked. Through backend means described with reference to FIG. 3, the consumer will be switched to the plan offered by the service provider in the best market offering area 601.

The top 10 market offerings residing on the plan database, which match the consumer data received, are displayed in area 603. They are sorted by the lowest overall monthly bill resulting from each market offering. If the consumer wishes to compare selected plans in greater detail, the consumer may select the plans for comparison. This selection may be performed by any suitable means, including the checkboxes shown at 605. After the selected plans are chosen, a Compare button 604 is clicked, causing a side-by-side comparison screen to be displayed, as shown in FIG. 6B. If the consumer wishes to register and receive notification of goods and service updates, a Save & Register button 606 may be selected, causing the screen shot shown in FIG. 6C to be displayed.

Where the methods shown in FIG. 1 or FIG. 4 have been used to obtain the displayed results, the highest benefit market offerings may be determined, using assumptions about rates, call length, and cal distribution. For instance, where a user enters a geographic location, an average monthly or periodic bill amount, and a lifestyle selection, highest benefit market offerings may be determined, by assuming an industry standard rate, call length, and call distribution (in-state or out-of-state, on days, evenings, Saturdays and Sundays). These assumptions may be shaped by the lifestyle profile choice selected by the user. The assumed information may be by sources, such as the Federal Communications Commission (FCC) or private survey sources, including on-line consumer data gathering sources that may be tied to the PDC system employing the user interface of the current invention.

FIG. 6B shows an Internet web page 61 containing a side-by-side comparison of several selected plans that resulted from the consumer selecting the Compare button in FIG. 6A. The side-by-side comparison 611 includes estimated savings, quality rating, various rates and fees associated with each of the selected plans.

FIG. 6C shows an Internet web page 62 for creating an account and receiving notification of goods and service updates that resulted from the consumer selecting the Save & Register button in FIG. 6A. Registration requires the consumer's name 621, an email address 622, a password 623, and a promotional code 624. If the consumer is interested in receiving notification of goods and service updates, a Yes box 625 is selected and a Next button 626 is clicked, which causes a confirmation page to be displayed. The confirmation page may comprise any page suitable for confirming the consumer's entered identification information and wish to receive notification of updates.

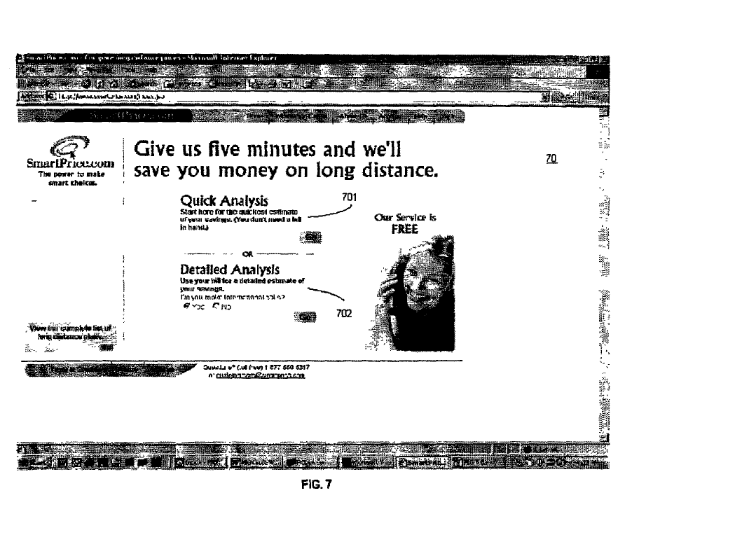

The extent of information input by the consumer, as shown in the embodiments illustrated by FIG. 4 and FIGS. 5A and 5B may be used separately, or may be offered to a consumer in the alternative. For example, in FIG. 7, an Internet web page 70 is shown, which introduces a user interface for a PDC system, in accordance with one embodiment of the present invention. The web page 70 offers the consumer a choice of a quick analysis, 701, which takes the consumer to the input page described with reference to FIG. 4. Alternatively, the page 70 offers the consumer the choice of a detailed analysis, 702, which takes the consumer to the input pages described with reference to FIG. 5A and 5B.

Although the present invention has been described in detail with reference to certain preferred embodiments, it should be apparent that modifications and adaptations to those embodiments, such as altering the order in which inputs are received, may occur to persons skilled in the art without departing from the spirit and scope of the present invention as set forth in the following claims.

1. A profile driven method in a computer system for displaying market offerings to a consumer, comprising:
displaying information about a selected category of goods and services; receiving consumer selected profile information that most closely matches consumer usage of the selected goods and services category; and
displaying one or more market offerings in the selected goods and services category that provides a highest benefit to the consumer based on the selected profile information.

2. The method of claim 1, further comprising:
receiving an indicia of a consumer geographic location; and
displaying one or more market offerings in the selected goods and services category that provides a highest benefit to the consumer based on the selected profile information and the consumer geographic location.

3. The method of claim 1, further comprising receiving a designated market offering from the consumer for supplying the selected category of goods and services to the consumer.

4. The method of claim 1, wherein the step of displaying one or more market offerings comprises displaying one or more market bundles where each market bundle includes a plurality of market offerings from different categories of goods and services.

5. The method of claim 1, further comprising displaying a detailed comparison of the market offerings in the selected goods and services category that provides the highest benefit to the consumer based on the selected profile information.

6. The method of claim 1, further comprising receiving a request from the consumer for receiving future notification of high benefit market offerings.

7. The method of claim 1, further comprising displaying estimated benefits of the market offerings in the selected goods and services category that provides a highest benefit to the consumer based on the selected profile information.

8. The method of claim 7, wherein the step of displaying estimated benefits comprises displaying estimated benefits selected from the group consisting of monthly fees, quality rating, lowest cost, highest quality, highest reliability, fastest response, consumer support services, available promotions, equipment costs included, installation charges included, and prompt delivery.

9. The method of claim 1, wherein the step of displaying information comprises displaying information about a selected category of goods and services chosen from the group consisting of local telephone service, variable cost long distance, fixed cost long distance service, wireless service, broadband service, dial-up Internet service, natural gas service, electric service, entertainment service, airline reservation service, information service, grocery service, financial service, insurance, commodity goods, cable television, satellite television, credit cards, conference calling and calling cards.

10. The method of claim 1, wherein the step of receiving consumer selected profile information comprises receiving consumer selected profile information chosen from the group consisting of periodic bill amounts, time related usage information, geographic related usage information, number of users, frequency related usage information, desired features and risk tolerance.

11. The method of claim 2, wherein the step of receiving an indicia of a consumer geographic location comprises receiving an indicia of a consumer geographic location selected from the group consisting of telephone area code, telephone exchange digits, city designation, state designation, and postal code.

12. The method of claim 1, wherein the step of displaying one or more market offerings comprises:
displaying a provider name for the highest benefit market offering;
displaying the monthly average bill amount received form the consumer;
displaying an estimated average monthly bill amount for the highest benefit market offering;
displaying a monthly savings amount; and
displaying a quality rating for each displayed highest benefit market offering.

13. A software program, embodied on a computer-readable medium, incorporating the method of claim 1.

14. A user interface method for a profile driven commerce system for displaying market offerings to a consumer, comprising:
selecting a category of goods and services by a consumer;
viewing displayed information about the selected category of goods and services;
selecting consumer profile information that most closely matches consumer usage of the selected goods and services category; and
viewing one or more market offerings in the selected goods and services category that provides a highest benefit to the consumer based on the selected profile information.

15. The method of claim 14, further comprising:
entering an indicia of consumer geographic location by the consumer; and
viewing one or more market offerings in the selected goods and services category that provides a highest benefit to the consumer based on the selected profile information and the consumer geographic location.

16. The method of claim 14, further comprising selecting a designated market offering by the consumer for supplying the selected category of goods and services to the consumer.

17. The method of claim 14, wherein the step of viewing one or more market offerings comprises viewing one or more market bundles where each market bundle includes a plurality of market offerings from different categories of goods and services.

18. The method of claim 14, further comprising viewing a detailed comparison by the consumer of the market offerings in the selected goods and services category that provides the highest benefit to the consumer based on the selected profile information.

19. The method of claim 14, further comprising inputting a request by the consumer for receiving future notification of high benefit market offerings.

20. The method of claim 14, further comprising viewing estimated benefits by the consumer of the market offerings in the selected goods and services category that provides a highest benefit to the consumer based on the selected profile information.

21. The method of claim 20, wherein the step of viewing estimated benefits comprises viewing estimated benefits selected from the group consisting of monthly fees, quality rating, lowest cost, highest quality, highest reliability, fastest response, consumer support services, available promotions, equipment costs included, installation charges included, and prompt delivery.

22. The method of claim 14, wherein the step of viewing displayed information comprises viewing displayed information about a selected category of goods and services chosen from the group consisting of local telephone service, variable cost long distance, fixed cost long distance service, wireless service, broadband service, dial-up Internet service, natural gas service, electric service, entertainment service, airline reservation service, information service, grocery service, financial service, insurance, commodity goods, cable television, satellite television, credit cards, conference calling and calling cards.

23. The method of claim 14, wherein the step of selecting consumer profile information comprises selecting consumer profile information chosen from the group consisting of periodic bill amounts, time related usage information, geographic related usage information, number of users, frequency related usage information, desired features and risk tolerance.

24. The method of claim 15, wherein the step of entering an indicia of a consumer geographic location comprises receiving an indicia of a consumer geographic location selected from the group consisting of telephone area code, telephone exchange digits, city designation, state designation, and postal code.

25. The method of claim 14, wherein the step of viewing one or more market offerings comprises:
viewing a provider name for the highest benefit market offering;
viewing the monthly average bill amount received form the consumer;
viewing an estimated average monthly bill amount for the highest benefit market offering;
viewing a monthly savings amount; and
viewing a quality rating for each displayed highest benefit market offering.

26. A software program, embodied on a computer-readable medium, incorporating a computer-implemented method of providing the user interface method of claim 14.

27. A computer system for displaying market offerings to a consumer, comprising:
means for displaying information about a selected category of goods and services;
means for receiving consumer selected profile information that most closely matches consumer usage of the selected goods and services category; and
means for displaying one or more market offerings in the selected goods and services category that provides a highest benefit to the consumer based on the selected profile information.

28. The computer system of claim 27, wherein the means for displaying is a computer display terminal.

29. The computer system of claim 27, wherein the means for receiving is a computer keyboard.

30. The computer system of claim 27, wherein the means for receiving is a computer mouse.
